(19) United States
(12) Patent Application Publication
(10) Pub. No.: US 2002/0026535 A1
(43) Pub. Date: Feb. 28, 2002

(54) Method for phase oriented internet business agents

(76) Inventor: Karur Srinivasan, Thornhill (CA)

Correspondence Address: Karur S. Rangan, 36 ABERFELDY CRES., THORNHILL, ON, L3T-4C2, CA

(21) Appl. No.: 09/942,701

(22) Filed: Aug. 28, 2001

Related U.S. Application Data
(60) Provisional application No. 60/229,248, filed on Aug. 30, 2000.

(51) Int. Cl. G06F 9/46

(52) U.S. Cl. 709/320

(57) ABSTRACT

A method and architecture for managing interaction processes over a network of specialized servers linked through the internet or an intranet system based on using agents that are specific to a phase of the interaction process. All information is segregated into three categories, process, rules and data layers. Rules and data information are unique to a particular client. Process information and process programs are common to and can be shared by all clients, and only process information is transmitted between clients. Clients must map their local data to rules, and rules to common process information. Agents for any interaction may act independently of the time sequence of the process. Since clients only transmit process information, interactions can occur between any platform or data architecture. Clients do not have to conduct one to one mapping of client systems to interact. Rules can include automation of the interaction process.

### REFERENCE TO PROVISIONAL APPLICATIONS TO CLAIM PRIORITY

This application claims priority in provisional application filed on Aug. 30, 2000, first entitled “Internet Business Agents,” application Ser. No. 60/229248 by inventor Karur S. Rangan.

### FEDERALLY SPONSORED RESEARCH Not Applicable

### SEQUENCE LISTING OR PROGRAM Not Applicable

### BACKGROUND OF THE INVENTION

1. Field of the Invention

This invention relates to the development and deployment of software agents and an architecture to perform business functions over the Internet. The concepts and the software algorithm described here can be employed in stand alone or distributed processing environment using local networks or the Internet.

2. Discussion of Prior Art

A “Software Agent” is a computational system, which is long lived, has goals, sensors and actuators and decides autonomously which actions to take in the current situation to maximize progress towards its time varying goals.

An “architecture” is a method employing hardware and/or software that allows hardware and/or software (in this case agents) to interact.

There are patents covering Agents software and Rules based systems. However, the agents and the architecture described in those patents are only designed to perform specific sets of tasks. The software agents are Task and Data specific and are only able to perform their functions within the designed limited domains. The architecture is only designed to allow messaging between agents using simple protocols and data structures.

At most, existing patents set out efficient methods for information utilization based on a specific domain, not new methods for utilizing information from different domains.

Few examples are described below.

Inventors: Hodjat, et al.

Date: Nov. 7, 2000

Pat. No. 6,144,989

Title: Adaptive agent-oriented software architecture

Problem: This architecture is based on a network of agents and for processing of messages it hunts down the hierarchy to determine as to which agent can handle the message. Each agent has its own domain of responsibility and cannot work outside its domain.

Inventors: Ueno, et al.

Date: Jul. 10, 2001

Pat. No. 6,260,059

Title: Knowledge provider system and knowledge providing method utilizing plural knowledge provider agents which are linked by communication network and execute message processing using successive pattern matching operations

Problem: This patent also processes the messages through a network of agents. The ability of the agents is determined by matching the pattern of the message to the agents' solvable patterns. Again, this logic is not generic and has no way of performing outside of its domain.

Inventors: Moore, et al

Date: Jun. 7, 1995

Assignee: International Business Machine Corporation (Armonk, NY)

Pat. No. 5,630,127

Title: Program storage device and computer program product for managing an event driven management information system with rule-based application structure stored in a relational database

Problem: This is a method of storing rules against database items. These rules are oriented to individual data items and have no means of porting to other contexts.

Current Internet technologies suffer from a number of disadvantages that prevent the Internet from being used as an automated business process integration tool.

1. Current methodologies cannot cope with interactions between dissimilar systems without a specially designed standard interface protocol between them. These methodologies and protocols are task specific and end users cannot easily change their behaviors.

2. Exchange and processing of information between systems requires costly development of programs that adhere to the specified methodology and protocols.

3. All clients can only participate in the process integration if they each follow the same identical procedures..

4. A high degree of manual intervention is required to manage all tasks.

5. Since such protocols have to be shared between all participants, business intelligence is not secured. Only infrastructure security is available.

6. The programs have to be shared on a trusted basis. A degree of control as exercised by a librarian is difficult to achieve.

7. Ensuring completion of tasks and providing audit ability is difficult.

The prior art in this area suffers from the “misconception is that agents based system can be developed simply by throwing together a number of agents in a melting pot; that the system requires no real structuring and all agents are peers.”(Wooldridge, Michael and Jennings, Nicholas R, Pitfalls of Agents-Oriented Development, Department of Electrical Engineering, Queen Mary & Westfield College, University of London, UK, 1998, section 7.5)

What is needed is a move away from the task centric methodologies and to focus our thinking on dividing the tasks into phases and monitoring the phases.

### OBJECTS AND ADVANTAGES

The main objective of this invention is to provide for heterogeneous systems to interact with each other on a one to one, one to many or many to many basis. Participating systems need only use local rules to link their data with the interaction space (an ib-office which supports many business functions in ib space, for example, mailbox). The entire interaction process is broken into phases and the interaction is managed by phase oriented agents. ). Therefore, the interacting systems need only focus on the phase of the task on hand, point to point tailoring of interactions between processes is eliminated. These agents may trigger respones in the recipient system(s).

The processing logics required for the phases can easily be generalized. Thus, we can minimize cost of developing process integration. Further, we can provide ability to customize and change the behavior of such systems logics.

Securing Business Intelligence, ability to provide audit trail and librarian control over programs that respond to each other are part of this invention.

Advantages derived from the above are:

1 The Phase approach allows us to eliminate the need for a user to create agents that must perform a long sequence of steps or for people to intervene between steps. Further, the phases are independent of each other and of the underlying business rules and data. Thus, heterogeneous systems can participate without implementing a rigorous protocol.

2 The algorithms that implement the logics of the phases are generalized and hence can be shared in a controlled manner. Hence, development costs can be minimized.

3 The clients control their business rules and their data structures. They need not implement a standard methodology or system for interaction. They only have to create local rules that allow their system to link to the interaction space (ib-office). Thus, the Clients need not divulge or permit interference to their business intelligence.

4 The Clients rules can be driven by a separate Rules engine that allow dynamic changes to the rules. This helps the clients to make quick decision to alter behavior of the phases.

5 As part of the rules, warning and alerts can be specified. This will minimize manual intervention.

6 The business rules are under each client's control and need not be shared. Thus business intelligence is not compromised.

7 The programs that form the phase logics are not transported, shared or exchanged. Only the interface data are exchanged between clients. No associated tags for the data identifications are part of the data exchange thus providing a level of security against eavesdroppers. The program logics for the phases can be distributed through a controlled library system of servers.

8 The programs associated with the phases work autonomously. They are initiated by contexts, events or time. They end when they achieve results or encounter other terminating events. On normal ending, the initiating context would change. These programs will be reinitiated automatically per rules if the contexts persist. A log of completed and pending contexts will help in verifying completion and otherwise setup warnings and alerts.

9 Another benefit of breaking the tasks by their phases is improved CPU utilization. This will results in improved CPU efficiency and use of multiple CPUs.

Please note, the term “Programs” is used to mean software agents. Composition of these agents is described in the preferred embodiment section.

### SUMMARY OF THE INVENTION

The main object of this invention is to provide a means for multiple processes to manage their interfaces efficiently without having to individually develop each interface. This is achieved by developing interface agents, known as “ibAgents”, that are universally applicable. “Clients” employs these generic ibagents to interact with other Clients. Each client has their own set of local rules and local data interfaces.

The ibAgents are not function or task specific. They are classified by a specific phase of the interaction process, Discovery, Negotiate, Facilitate, Monitor, Close, Audit and Alert. The Clients can manage their interface dynamically by manipulating their local rules and data.

### BRIEF DESCRIPTION OF THE DRAWINGS

The environment

FIG. 1: ibAgents Network Configuration. A view of how the Internet service providers will include this invention's services. And how users of the facilities provided by this invention will operate using the Internet.

FIG. 2: ibClient Configuration. A view of the users' environment, their use of ibAgents, local interface database and user display.

FIG. 3: ibServer Configuration. A view of how users requests will pass through from the users to the Internet.

Architecture—Information layers and phases

FIG. 4: ibAgent architecture. A view of the how the information is segregated into layers.

FIG. 5: ibAgent Object Hierarchy. Shows how the information processing is divided into phases.

FIG. 6: ibAgents Configuration. Shows the building of an agent using the information architecture and the objects from the object hierarchy.

FIG. 7: ibAgents logics overview (Discovery, Negotiate, Facilitate, Monitor and Close). Shows how ibagents operate to provide the functionalities of Discovery, Negotiate, Facilitate, Monitor and Close phases.

FIG. 8: ibAgents logics overview (Alert—Warning). Shows how ibagents provide warnings to the users. (Alert phase)

FIG. 9: ibAgents logics overview (Alert—Critical). Shows how ibagents will be altered. (Alert Phase)

FIG. 10: ibAgents Audit facility. Show how auditing facilities is provided.

FIG. 11: ibAgents communications (Send & Receive). Shows how messages are sent and received in a secured fashion through the Internet.

FIG. 12: ibAgents library control. Shows how ibAgents process logics are distributed in a control manner.

### DETAILED DESCRIPTION OF THE PREFERRED EMBODIMENTS

The environment

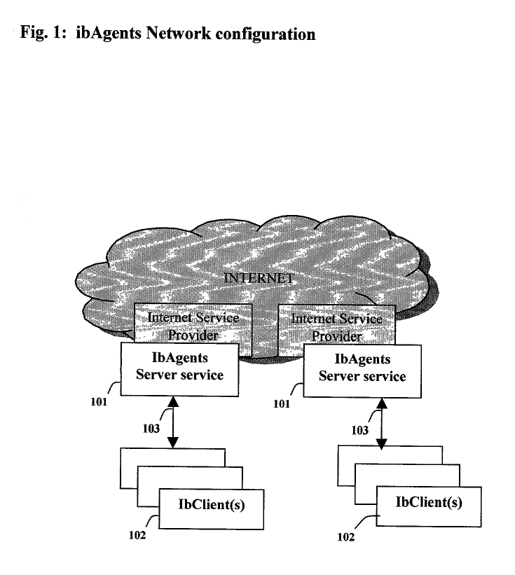

FIG. 1 Shows in the preferred embodiment of the present invention as to how an Internet service provider will include this invention's services, and how users of the facilities provided by this present invention will operate using the Internet. It includes the present invention server service (ibAgents server service) 101 at the internet service provider's location, the present invention software (ibClients) 102 at the user's location, and the internet communication 103 between the user and the service provider.

The present invention server service (ibAgents server service) 101, comprises of software and data that are used at the server site. The present invention client applications (ibClients) 102, comprises of software and data that are used at the user's computer. The communication link 103, is the internet service link from the user to the service provider.

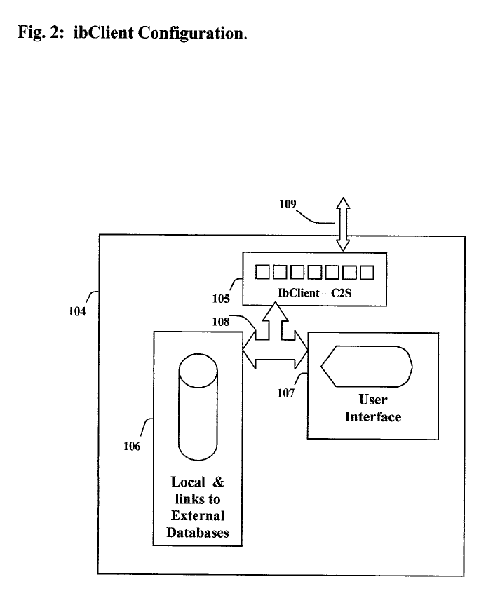

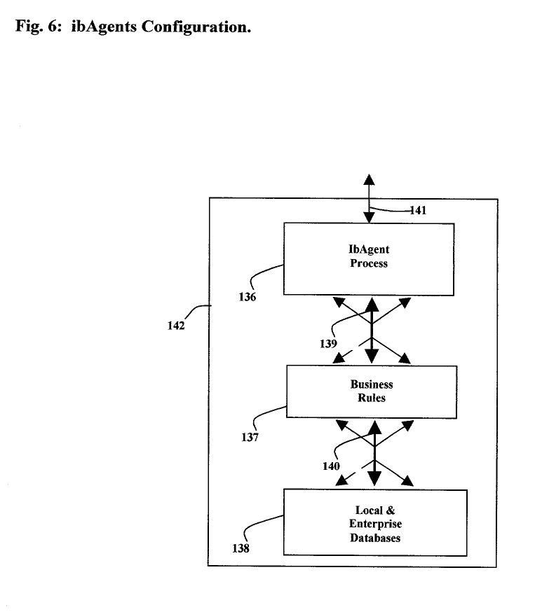

FIG. 2. A breakdown of the client's applications 102 in FIG. 1 is show here and is termed as ibClient configuration 104. The ibClient configuration 104 comprises of storage of data locally and links to external databases 106, user interface methods including displays 107, and agent software 105. The user stores his processing requirements in a set of rules in the local database. The agents are capable of being invoked by contexts in the local database, time or other interruptions. The behavior and performance of the agents are configured as explained later in FIG. 6 and are dynamically modified by the user by changing the rules. The agents send out and receive data streams 109. These data streams are known as the “repertoire” form the basis of interactions with other processes.

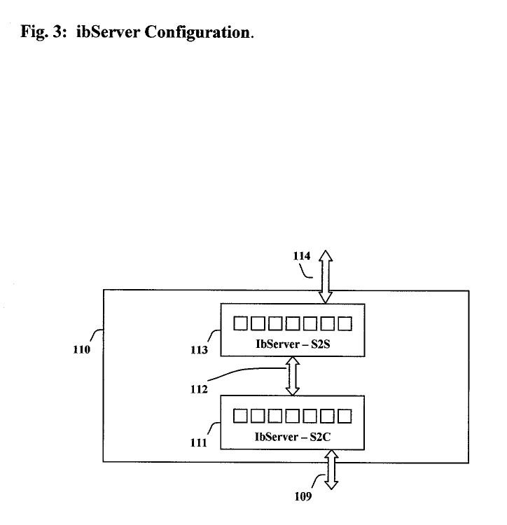

FIG. 3. A breakdown of the server service 103 in FIG. 1 is shown here and is termed as ibServer configuration 110. The ibserver configuration comprises of agents 111 that interact with the client agents (“S2C” means Server to Client) 105 in FIG. 2, internet communication link 109 between ibclients in FIG. 2 and the ibserver, agents (“S2S” means server to server) 113 that communicate with other internet servers, the internet communication between ibservers and the internet servers 114, and the communication between client side and internet side software 112.

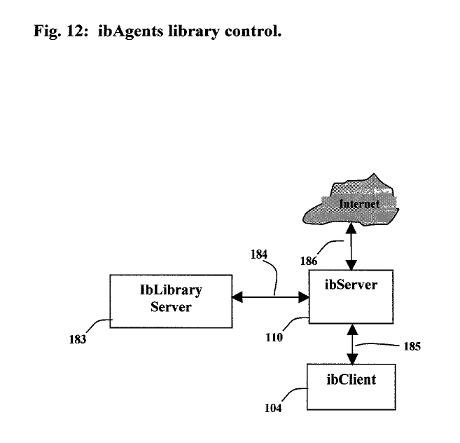

The ibserver functions include methods to wrap and unwrap the ibagents messages to internet message format and thus prepare the message for movement through the internet. Further, the ibservers authenticate the registration of the user and the communicated repertoires. This forms part of the library control shown later in FIG. 12.

The structure described in FIGS. 1, 2 & 3 allows establishment of ibagents web space within the Internet with ibagents own business intelligence security. In this web space, the present invention allows establishment of electronic offices known as “iboffices”. The ibOffices are described as ibClients in FIGS. 1, 2 and 3. The iboffices have their own in and out mail boxes as part of local database, local office workers as agents and business rules stored in the local database to a set of office procedures.

Architecture—Information layers and phases

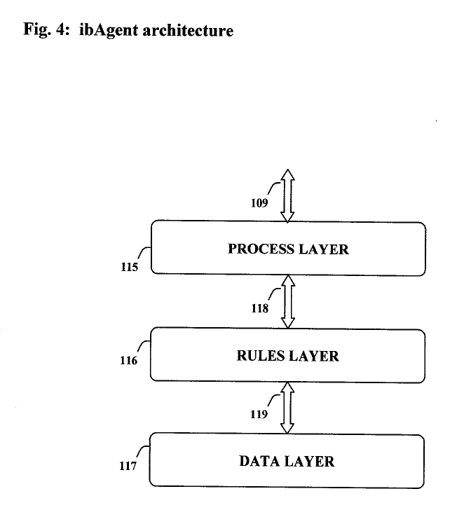

FIG. 4 shows how the information is segregated into layers that are managed independent of each other. The architecture used by the present invention comprises of a process layer 115, a rules layer 116 and a data layer 117.

The process layer 115 contains the agents that can perform operations. The agents will refer to the rules in the rules layer and dynamically link with the rules during execution. The rules when invoked by the agents return data streams to the agents. The agent processes the data items in the data streams by focusing on the generic definition of the data items. The agents' processes are not tightly coded to the exact meaning of the data items but are coded to meet the generic functionality of the type of agent. Thus agents become usable across functional and other restrictive boundaries. The meaning of each data item contained in the repertoire (FIG. 3 109) is passed to the interfacing processes through a data definition for the repertoire through library controls.

The rules layer 116 contains business rules. These rules define the links to the data layer and data items to be processed. They prescribe the processing to be done on the data items and refer to the exact meaning of the data items. The rules also define the data items to be passed to the agents. The exact meaning of the data item is replaced by a generic meaning in the data stream sent to the agent.

The data layer 117 comprises of local database and set of stored procedures to access external databases. The rules in the rules layer refer to the stored procedures and data items in the local database. When the agents invoke the rules, the rules in turn access the data in the data layer.

The link 119 carries the data between the data and the rules layer with exact definitions for the data items and the data structures.

The link 118 between rules layer and process layer carries data with generic definitions.

The link 109 is the repertoire that passes to the ibserver.

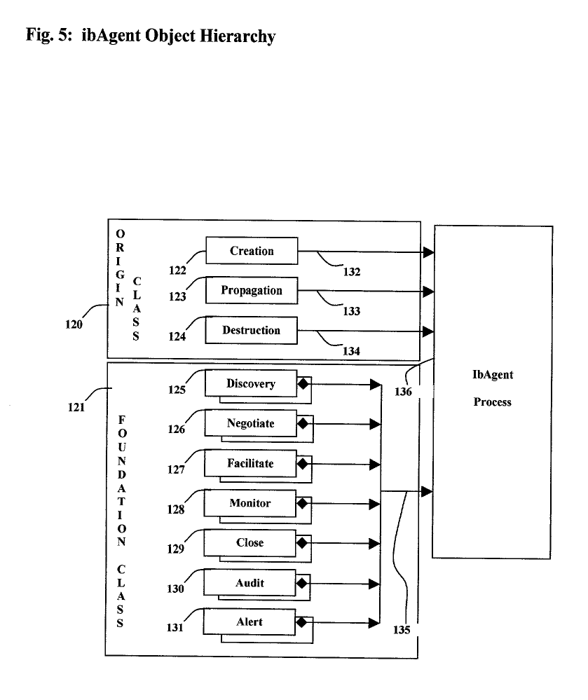

FIG. 5. Shows a set of basic program modules that can be used in building agents. The basic modules are grouped in to two separate classes. Each class, origin 120 and Foundation 121 contain objects that provide functionalities to agents. All agents posses all origin class 120 objects, creation 122, propagation 123, and destruction 124. There are seven major groups of foundation class objects, discovery 125, negotiate 126, facilitate 127, monitor 128, close 129, audit 130, and alert 131. In the foundation class 121 there are many types of objects within each group. Agents will only posses one type of foundation class 121 object.

The present invention divides all computer processes into seven phases, or steps. Each major group of the foundation class 125-131 represent a phase. The computer process is completed when all phases have been completed.

The properties and procedures of a foundation class 121object are inheritable in the creation of new objects with the same group.

Object 122, Creation object, provides means of identifying any derived object's time of generation. Additionally, it holds the type of created agent.. Object 123, Propagation object, provides means of responding to other agents. Also it keeps progress of the agent and criteria to measure progress. Object 124, Destruction object, provides means terminating the derived agents and criteria to invoke destruction of the agent. Object 125, Discovery object, provides means of searching and selecting an optimum result from a given set of input data streams. These objects are used in creating agents for searching client's own or others data. Object 126, Negotiate object, provides means of responding to different scenarios and associated data streams. The results of negotiate object are data items, data streams and indicators showing where those results are to be applied. These objects are used in creating agents to evaluate responses from other processes.

Object 127, Facilitate objects are used to create agents to get confirmations from other processes. Object 128, Monitor objects evaluate progress of other objects and calls for user intervention when needed. Object 129, Close objects ensures proper completion of tasks. Object 130, Audit objects ensures proper audit trails are created as each object completes its operation. Object 131, Alert objects create alerts when agents do not perform, or provide responses according to design.

Ibagents are created using these objects. IbAgent process 136, inherits objects 122. 123.124 and any one of objects 125 through 131. The inheritances are shown as lines 132, 133, 134 and 135.

FIG. 6. Shows the building of an agent using the information architecture and the objects from the object hierarchy. The ibagent 142 comprises of the ibagents process 136 as detailed in FIG. 5, links to Business rules 137. Business rules 137 are linked to one or more local and enterprise databases 138. 139 show the connections between ibagent process 136 and business rules 137. An ibagent process can be associated with one or more business rules and any business rule can be used by one or more ibagent process. 140 show the connection between the business rules and the stored query procedures. Again it can be one to one or one to many connections either way.

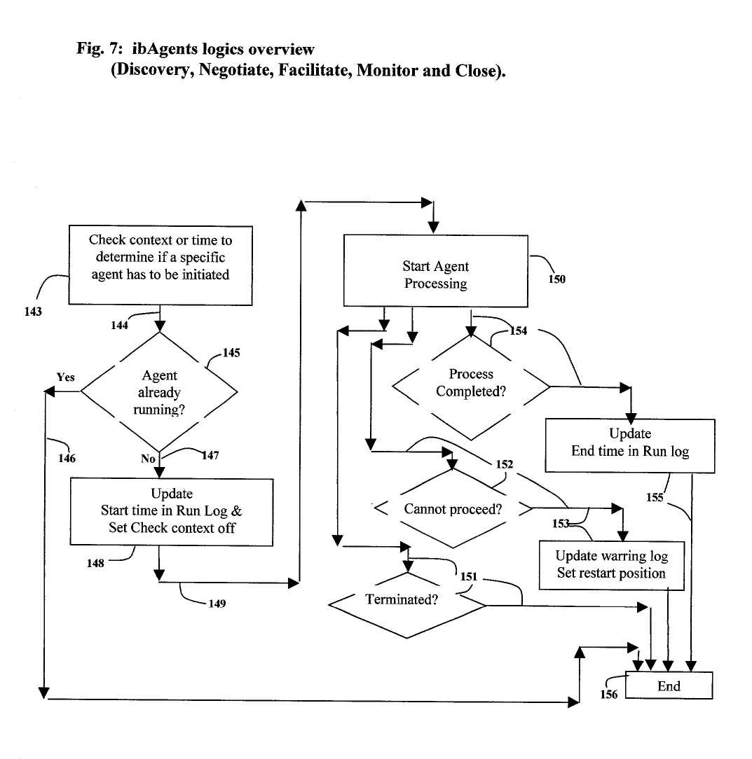

FIG. 7 shows how ibagents operate to provide the functionalities of Discovery, Negotiate, Facilitate, Monitor and Close phases.

143 shows that each agent is initiated by a trigger from the local database based on a context (i.e. criteria which initiate actions), or an interrupt or a specific time. On initiation 144, if the agent is already running 145, a new instance of the agent is not created 146. If the agent is not already running 147, the run log is updated and the context testing is turned off 148 and the agent starts processing 149 and 150. During agent processing, one of three following event could occur. (a) If the agent hits a major software or hardware problem, it cannot process any more and the agent will terminate 151. Based on the severity of the problem the agent process may or may not reach the end 156. (b) The agent process cannot proceed because of inconsistencies in data 152 it will flag a warning 153 and end the process 156. (c) The agent process completes as expected 154, the run log is updated 156 and the process ends.

This logic is designed so that the agent can reattempt in case of failure and does not interfere with other agents processing. Also, data errors and data inconsistencies are not hold the processes from running but such conditions are flushed out with a warning.

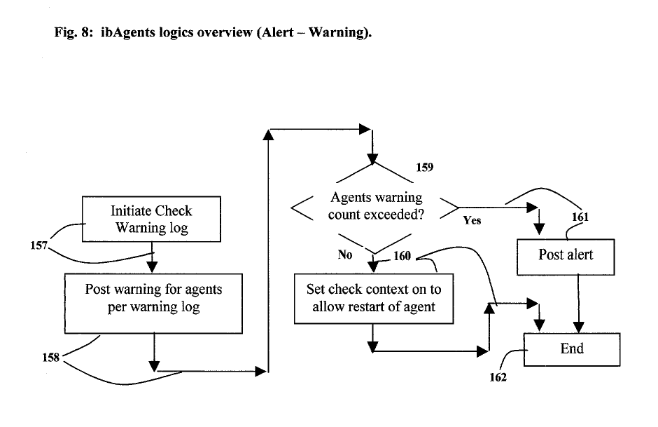

FIG. 8 shows how ibagents provide warnings to the users. (Alert phase).

Warning logs are checked on a timely basis or on events that require immediate attention, like too many warnings of the same kind within a short period 157. A waning is posted to the warning log and the warning count by agent is checked 158 and 159. If the count (which can be set by the user for a particular agent. Note there may also be a default count) is not exceeded, the Check context is turned on that will allow restart of the agent and the warning process is ended. If the warning count has exceeded, the alert is posted and the warning process is ended.

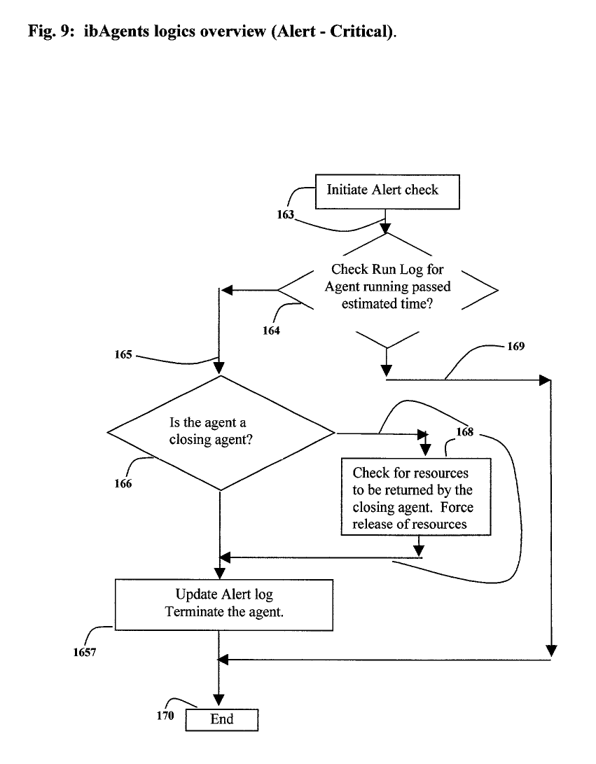

FIG. 9 shows how ibagents will be altered. (Alert Phase)

Alert checks are initiated periodically and by other termination events. 163. A check on active agents processing duration will be done 164. If any agent has exceeded the time limit 165, and if the agent is not a closing agent 166 the alert log is updated and the agent is terminated 167 and the alert process ended 170. If the agent is a closing agent 166, the resources that closing agent was trying to release will be forcefully released 168 and the alert log is updated and the agent is terminated 167 and the alert process ended 179. If there are no alerts 169, the alert process is ended.

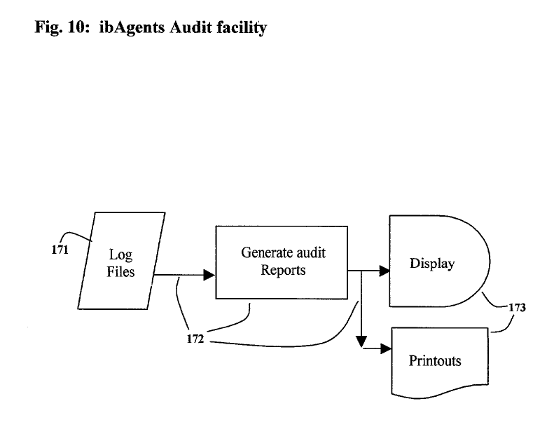

FIG. 10. Show how auditing facilities is provided. The audit report can be generated from the log files 171. The procedures and the processing links 172 can be invoked as needed. The results can be displayed or printed out 173.

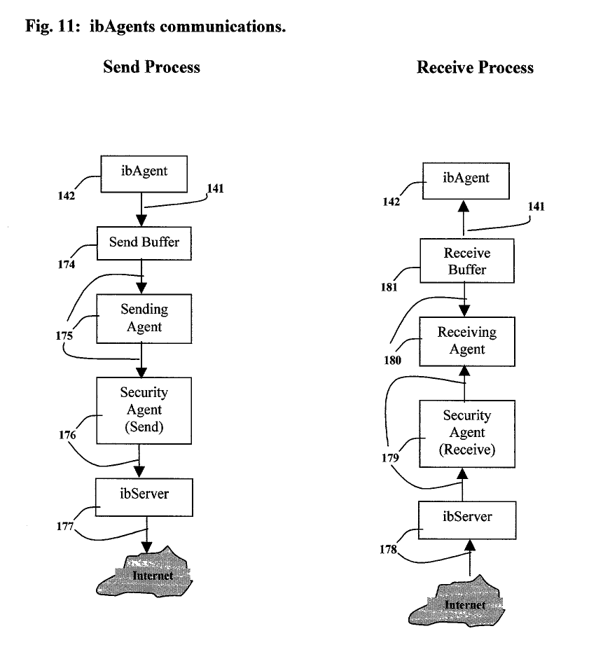

FIG. 11 Shows how messages are sent and received in a secured fashion through the Internet.

The send process starts from the ibagent 142 repertoire 141. This repertoire is stored in a send buffer on the client system 174. The sending agent 175 scans the send buffer 174, adds destination addresses and passes it to the security agent 176. The security agent 176 splits the repertoire randomly in fagments, encodes them, puts ibagents security tags and passes it to ibserver 177. ibServer may perform a security function on the individual fragmetns (e.g. encryption). The ibserver then wraps the entire bundle with an internet wrapper so that the message can pass through per internet protocol.

The receive process is exactly the reverse process. Ibserver 178 gets messages from the internet. If the package is a ibagent package the internet wrapper is removed, and the ibserver removes the internet securoty and passed to the security agent 179. The security agent stores the message temporarily until it receives the other message fragments. The messages are then joined together knowing the formula for joining together determined through a preset of rules. The joined message is then passed to the receiving agent 180. The receiving checks the tags and stores the message in the receive buffer 181. The repertoire 141 tag helps in invoking the corresponding ibagent.

The information splitting and joining occurs on the client system 173 and 176. There are 2 security stages. The first occurs on the client system by the of the security agent 173 and 176. The second is for infrastructure security (encryption, etc.) which occurs on the host system 174 and 175.

This security system is designed over and above the internet infrastructure security. This ibagent security prevents business knowledge being interrogated or tampered by any other process.

FIG. 12 shows how ibAgents process logics are distributed in a controlled manner.

In the present invention, agents are not transported. Agents are distributed through a set of controlled libraries. The ibserver 110 checks the message tags to identify the agent required by the clientv. Ibserver maintains a catalog of agents that are supplied to the ibclient. If the agents library term has expired or new items is requested, it is supplied from the library.

### Operations of the Prefferred Embodiment

Already included as part of detailed description.

We claim:

1. A method of governing the deployment and control of software programs over the internet and intranet to conduct business transactions in a co-operative manner, comprising of
a. multitude of server side services employing the server side version of the said software programs
b. multitude of client side services employing the client side version of the said software programs
c. said multitude of server side services being able to communicate with one another using the internet or intranet
d. said client side services being able to communicate to one of the said multitude of server side services
e. said method of governing the software programs controlling the authentication, deployment and operation of the software programs
whereby the said method of governing provides a means for the said client side services to interact with other said client side services without the need to conform to a common client side software, hardware, language or business practice,
whereby the said method of governing provides a means for the said client side service to employ their own methods of storing their data and viewing details of their business transactions and
whereby the said method of governing provides a means for the said client side services to interact with said server side services using the relevant said software programs.

2. The said multitude of client side services of claim 1 comprises of
a. means of storing data locally,
b. means of accessing external data through the said means of storing data locally,
c. means of displaying and evaluating the information that is stored or accessed by the said means of storing and accessing data
d. means for the said client side software to be invoked through interruption and conditions generated by the said means of storage of data and said means of displaying and evaluating information, and
e. means for the said client side software to access and modify the means of said storage and means of said display of information
Whereby the said client side service can operate using conditions and interruptions generated by the said data storage and display means, thus minimizing the need for manual intervention and
Whereby the said multitude of client side services can secure their data and business intelligence infringements from external sources, other said client side services and said server side services.

3. The said multitude of server side services of claim 1 comprises of
a. means of communicating between the said server side software and the said multitude of client side software and
b. means of communicating between the said server side software and the said multitude of server side software
whereby within network of said client side servers, recipient client side servers can be identified and information distributed securely between transacting client side servers, and
whereby other related services of this invention can be provided in a controlled manner.

4. A method of maintaining, managing and handling information in and between computer systems, which includes storage systems, by segregating said information into three categories, comprising of
a. a multitude of software programs, grouped as the process layer,
b. a multitude of business rules, grouped as the rules layer, that provide the business logics to run the said multitude of software programs of the said process layer,
c. a multitude of means of access to stored data in external or local databases, grouped as data layer,
d. a means for the said software programs of the said process layer to refer to information items in the said rules layer by their classified purpose and not by specific data layer names,
e. a means for the said business rules to refer to the information items and data procedures in the said data layer by specific names and to refer to the information items in the said process layer by their data classification name,
f. a means for recognition of data formats and conversion that is required for transmitting information between the said layers
whereby the data naming and mapping restrictions between the information items in the said process layer and the said rules layer is eliminated, and
whereby the said software programs in the said process layer can work with rules in any of the said rules layers of any other said client side rules layer as long as the required data classifications are mapped.

5. A method of initiating, conducting, concluding and monitoring a plurality of interactions between client side servers by using computer programs that are created to perform functions related to particular parts of the interaction process, comprising of
a. a group of said software programs known as the foundation class programs that comprises of programs to provide functionalities for
i. discovery
ii. negotiate
iii. facilitate
iv. monitor
v. close
vi. audit and
vii. alert processes, phases of the interaction process,
b. a group of said software programs known as the origin class programs that comprises of programs to provide functionalities for
i. creation
ii. propagation and
iii. destruction processes for the said executable programs in 5c, below
c. a means of creating an executable program to process the objective of a phase by combining one of the programs from the said foundation class and all programs from the said origin class and
d. a means of accessing data using said data classification names
whereby the said interaction process end results can be accomplished by said executable programs working in a coordinated fashion without strict control over the sequence in which they are executed, thus giving a flexibility to adapt these said executable programs to different business practices,
whereby the said executable programs can operate bypassing error conditions, and reattempt execution of the said interaction process and not interfere with said executable programs performing other said interaction processes and
whereby the said executable programs can be shared by other interaction processes in other said client servers.

6. The said business process of claim 5 comprises of
a. means of building agents to accomplish end results of various phases of the said interaction process,
b. a means of combining the said executable program of claim 5 with the said business rules of claim 4 to construct said agents and
c. a means for the said agents to access the data in the said data layer in claim 4 through the rules in the said rules layer in claim 4.

7. The logics of the said agents of claim 6 will comprise of
a. a means to invoke the agent based on the conditions in the said interruption or data store of claim 2 or time
b. a means to start the agent processing if not already running and update the log files in the said data store of claim 2
c. a means to update the log files contained in the data store of claim 2 with the end result, being, successful completion, could not proceed, or terminated,
whereby the said log files can be verified and agent processes can be kept independent of other processes.

8. The logics for said agents of claim 6 for specialized warning agents will comprise of
a. A means to verify the said log files of claim 7 and either allow restart of the agent processing or set up an alert in the log file.

9. The said agents of claim 6 for specialized alert agents will comprise of
a. a means to verify if active agents have exceeded their run duration or created conditions that warrant termination of the said agent, and
b. a means to release resources held by the agent and terminate the agent,
whereby processing by other agents can continue without interruption.

10 A means of providing auditing facilities to create audit reports and files of agents of claim specializing in audit, comprising of,
a. the said log file of claim 7,
b. a means of displaying or printing audit results and reports,
whereby the audit records for end results of interaction processes can be created and maintained.

11 A method for providing secure transmission and reception of information comprising of:
a. means of splitting and encoding messages to pass through the Internet or intranet and
b. means of decoding and recombining messages
whereby the business intelligence is shared only by the intended parties of the transaction process.

12 A method of distributing said executable programs of claim 5 in a controlled and secured means consisting of
a. a means to store and distribute the said executable programs of claim 5
b. a means of storing programs to provide management of a library of programs
c. the means of building executable programs of claim 6
whereby the information of the said process layer in claim 4 can be transmitted and received by the interacting parties,
whereby the said server side of the receiving party can check and provide the appropriate said software program for the said process layer to the said client server of the recipient,
whereby the recipient's said client side server creates the said agent automatically to conduct the interaction requested by the sending said client side server.
